(19) United States
(12) Patent Application Publication
(10) Pub. No.: US 2007/0197111 A1
(43) Pub. Date: Aug. 23, 2007

(54) Method for finishing absorbent materials

(75) Inventors: Cedric Dieleman, Scheibenhard (FR); Harald Keller, Ludwigshafen (DE); Axel Ebenau, Limburgerhof (DE); Jurgen Reichert, Limburgerhof (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/569,330

(22) PCT Filed: May 17, 2005
(86) PCT No.: PCT/EP05/05347

§ 371 Date: Nov. 17, 2006

(30) Foreign Application Priority Data
May 19, 2004 (DE) 10 2004 025 367.6
Jul. 22, 2004 (DE) 10 2004 035 654.8

(51) Int. Cl. B32B 27/12

(52) U.S. Cl. 442/118; 427/2.24

(57) ABSTRACT

A process for finishing absorbent materials by treatment with at least one aqueous liquor comprising at least one organic polymer, at least one organic or inorganic solid in particulate form, and
at least one emulsifier selected from emulsifiers of the general formula I 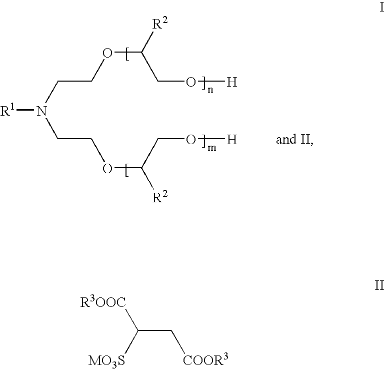 where:
R¹ is selected from C₆-C₄₀-alkyl,
R² is at each instance the same or different and selected from hydrogen and methyl m and n are the same or different and each selected from integers in the range from 0 to 10,
R³ is at each instance the same or different and selected from C₆-C₂₀-alkyl, M is an alkali metal or ammonium.

The present invention relates to a process for finishing absorbent materials by treatment with at least one aqueous liquor comprising
at least one organic polymer,
at least one organic or inorganic solid in particulate form, and
at least one emulsifier selected from emulsifiers of the general formula I

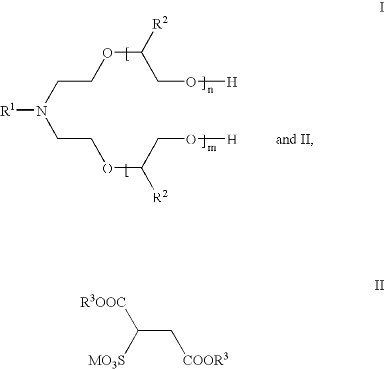

where:
R¹ is selected from C₆-C₄₀-alkyl and C₃-C₄₀-alkenyl having one to five C—C double bonds
R² is at each instance the same or different and selected from hydrogen and methyl
m and n are the same or different and each selected from integers in the range from 0 to 10,
R³ is at each instance the same or different and selected from hydrogen and C₆-C₂₀-alkyl,
M is an alkali metal or ammonium.

The finishing of textiles is a field of growing commercial importance. It is particularly interesting to finish textiles so as to render them water and soil repellent. Modern measures utilize in some cases the so-called Lotus-Effect® and confer water-repellent performance on textiles by applying a rough surface.

WO 96/04123 describes self-cleaning surfaces which have an artificial surface structure which has elevations and depressions, the structure being characterized by its structural parameters in particular. The structures are prepared for example by embossing a structure onto a thermoplastically formable hydrophobic material or by applying Teflon powder to a surface which has been treated with UHU®. U.S. Pat. No. 3,354,022 discloses similarly prepared water-repellent surfaces.

EP-A 0 933 388 discloses processes for preparing structured surfaces that comprise first preparing a negative mold by photolithography, using this mold to emboss a plastics film and then hydrophobicizing the embossed plastics film with fluorinated alkylsilanes.

However, the methods described above are unsuitable for soil- and water-repellent finishing of textiles.

WO 02/84013 proposes hydrophobicizing fibers, composed of polyester for example, by pulling them through a hot decalin bath at 80° C. in which 1% of Aerosil 8200 hydrophobicized silica gel has been suspended.

WO 02/84016 proposes hydrophobicizing woven polyester fabric by pulling it through a bath of hot DMSO (dimethyl sulfoxide) at 50° C. in which 1% of Aeroperl 8200 hydrophobicized silica gel has been suspended.

The two hydrophobicization methods share the feature that the solvent is selected such that the fibers are partially dissolved. This requires using large amounts of organic solvent, and this is undesirable in many cases. Moreover, treatment with organic solvents can have an effect on fiber-mechanical properties.

WO 01/75216 proposes rendering textile fibers and fabrics water and soil repellent by providing them with a two-component layer, of which one is a dispersion medium and the other is a colloid for example. The finishing process described in WO 01/75216 provides finishing layers in which the colloids are anisotropically dispersed in the dispersion medium in that the colloids are observed to become concentrated at the boundary layer between the finishing layer and the surrounding surface. The process utilizes finishing liquors which comprise up to 5 g/l of Aerosil 812 S.

However, textiles finished by the process described in WO 01/75216 lack satisfactory mechanical strength in many cases.

The present invention therefore has for its object to provide a process for finishing absorbent materials which is free of the disadvantages indicated above and which at the same time provides a very good water- and soil-repellent performance. The present invention further has for its object to provide soil- and water-repellent textiles. The present invention further has for its object to provide liquors for soil- and water-repellent finishing of absorbent materials.

We have found that this object is achieved by the process defined at the beginning.

Absorbent materials for the purposes of the present invention include for example paper, board, wood, building materials such as for example tile, concrete, natural stone, sandstone and sand-lime brick, also leather substitutes and leather and preferably textile materials. Textile materials are, for example, fibers, roving, yarn, thread on the one hand and textile fabrics on the other such as for example wovens, knits, nonwovens and garments. Particular preference is given to textile fabrics used for manufacturing outdoor textiles for example. Examples are sails, umbrellas, tarpaulins, groundsheets, tablecloths, awnings and furniture covers for example for chairs, swings or benches.

Absorbent materials for the purposes of the present invention can consist of different substances. Examples are natural fibers and synthetic fibers and also blend fibers. Examples of natural fibers are silk, wool and cotton. Examples of synthetic fibers are polyamide, polyester, polypropylene, polyacrylonitrile, polyethylene terephthalate and viscose. Similarly, modified natural fibers can be coated according to the process of the present invention, for example cellulose acetate.

The process of the present invention utilizes at least one aqueous liquor. Aqueous liquor for the purposes of the present invention comprehends liquors possibly comprising at least 5% by weight of water, based on fractions which are liquid at room temperature. The water content of aqueous liquors is preferably at least 25% by weight, more preferably at least 50% by weight and most preferably at least 75% by weight. The maximum water content, based on fractions which are liquid at room temperature is 100% by weight, preferably 97% by weight and more preferably 95% by weight.

Aqueous liquors used in this invention can comprise organic solvents, for example methanol, ethanol, isopropanol, acetone, methyl ethyl ketone, methyl isobutyl ketone, ethylene glycol mono-n-butyl ether, ethylene glycol monoisobutyl ether, acetic acid, n-butanol, isobutanol, n-hexanol and isomers, n-octanol and isomers, n-dodecanol and isomers, as well as water. Organic solvents can account for 0.2-50% by weight and preferably 0.5-35% by weight of the aqueous liquor used according to the present invention. Aqueous liquors having a water content of 100% by weight, based on fractions liquid at room temperature, accordingly comprise no organic solvents,

At least one of the liquors used in the process of this invention comprises at least one organic polymer. Organic polymers can serve as a binder. The action of a binder can be brought about for example by the organic polymer forming a film which binds the particles to each other and to the absorbent and preferably textile material to be coated.

In one embodiment of the present invention, at least one organic polymer comprises polymers or copolymers of ethylenically unsaturated hydrophobic monomers which have a 25° C. solubility in water of less than 1 g/l. in copolymers, hydrophobic monomers account for at least 50% by weight and preferably at least 75% by weight of the copolymer.

Preferred monomers are selected from the groups of the

C₂-C₂₄-olefins, especially α-olefins of 2 to 24 carbon atoms, for example ethylene, propylene, 1-butane, isobutene, 1-hexene 1-octene, 1-decene, 1-dodecene, 1-hexadecene or 1-octadecene,

vinyl aromatics, for example styrene, α-methylstyrene, cis-stilbene, trans-stilbene, diolefins such as for example 1,3-butadiene, cyclopentadiene, chloroprene or isoprene,

C₅-C₁₈-cycloolefins such as for example cyclopentene, cyclohexene, norbornene, dimeric cyclopentadiene,

vinyl esters of linear or branched C₁-C₂₀-alkanecarboxylic acids such as for example vinyl acetate, vinyl propionate, vinyl n-butyrate, vinyl n-hexanoate, vinyl n-octanoate, vinyl laurate and vinyl stearate,

(meth)acrylic esters of C₁-C₂₀-alcohols, for example methyl(meth)acrylate, ethyl(meth)acrylate, n-propyl(meth)acrilate, isopropyl(meth)acrylate, n-butyl(meth)acrylate, isobutyl(meth)acrylate, tert-butyl(meth)acrylate, 2-ethylhexyl(meth)acrylate, n-octyl(meth)acrylate, n-decyl(meth)acrylate, n-dodecyl(meth)acrylate, n-eicosyl(meth)acrylate

and most preferably from the groups of the halogenated monomers and the monomers having siloxane groups.

Halogenated monomers include chlorinated olefins such as for example vinyl chloride and vinylidene chloride.

Most particularly preferred halogenated monomers are fluorous olefins such as for example vinylidene fluoride, trifluorochloroethylene, tetrafluoroethylene, hexafluoropropylene, vinyl esters of fluorinated or perfluorinated C₃-C₁₁-carboxylic acids as described for example in U.S. Pat. No. 2,592,069 and U.S. Pat. No. 2,732,370 (meth)acrylic esters of fluorinated or perfluorinated alcohols such as for example fluorinated or perfluorinated C₃-C₁₄-alkyl alcohols, for example (meth)acrylate esters of HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₆F₁₃, HO—CH₂—CH₂-n-C₈F₁₇, HO—CH_{2—CH}₂-n-C₁₀F₂₁, HO—CH₂—H₂-n-C₁₂F₂₅,

described for example in U.S. Pat. No. 2,642,416, U.S. Pat. No. 3,239,557, BR 1,118,007, U.S. Pat. No. 3,462,296.

Similarly, copolymers of for example gycidyl(meth)acrylate with esters of the formula III

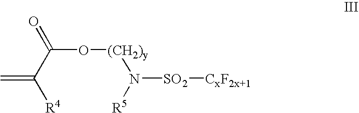

where,
R⁴ is hydrogen, CH₃, C₂H₅,
R⁵ is CH₃, C₂H₅,
x is an integer from 4 to 12 and most preferably from 6 to 8
y is an integer from 1 to 11 and preferably from 1 to 6,

or glycidyl(meth)acrylate with vinyl esters of fluorinated carboxylic acids are suitable.

Useful copolymers further include copolymers of (meth)acrylic esters of fluorinated or perfluorinated C₃-C₁₂-alkyl alcohols such as for example HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₅F₁₁, HO—CH₂—CH₂-n-C₆F₁₃, HO—CH₂—CH₂-n-C₇F₇F₁₅;

with (meth)acrylic esters of nonhalogenated C₁-C₂₀-alcohols, for example methyl(meth)acrylate, ethyl(meth)acrylate, n-butyl(meth)acrylate, n-propyl(meth)acrylate, 2-ethylhexyl(meth)acrylate, n-octyl(meth)acrylate, n-decyl(meth)acrylate, n-dodecyl(meth)acrylate, n-eicosyl(meth)acrylate.

An overview of suitable fluorinated polymers and copolymers is given for example in M. Lewin et al., Chemical Processing of Fibers and Fabrics, Part B, Volume 2, Marcel Dekker, New York (1984), pages 172 ff. and pages 178-182.

Further suitable fluorinated polymers are disclosed for example in DE 199 120 810.

From the group of the olefins having siloxane groups there may be mentioned for example olefins of the general formulae IV a to IV c

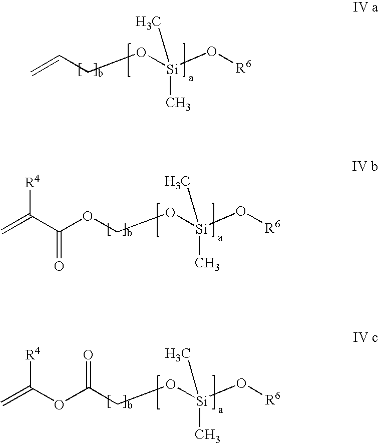

where:

R⁶ is selected from

C₁-C₁₈-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-dodecyl, n-tetradecyl, n-hexadecyl, n-octadecyl; preferably C₁-C₆-alkyl such as methyl, ethyl, n-propyl, isopropyl, n-buty, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄-alkyl such as methyl, ethyl, n-propyl, isopropyl, n-butyl, isobutyl, sec-butyl and tert-butyl and especially methyl.

C₆-C₁₄-Aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl C₃-C₁₂-cycloalkyl, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl or Si(CH₃)₃.

a is an integer in the range from 2 to 10 000 and especially up to 100.

b is an integer in the range from 0 to 6 and especially from 1 to 2;

Useful polymers further include: polyethers such as for example polyethylene glycol, polypropylene glycol, polybutylene glycols, polytetrahydrofuran;

polycaprolactone, polycarbonates, polyvinyl butyral, partly aromatic polyesters formed from aliphatic or aromatic dicarboxylic acids and/or aliphatic or aromatic dialcohols, for example polyesters formed from aliphatic dialcohols having 2 to 18 carbon atoms such as for example ethylene glycol, propanediol, 1,4-butanediol, 1,6-hexanediol, 1,8-octanediol or bisphenol A, and aliphatic dicarboxylic acids having 3 to 18 carbon atoms such as for example succinic acid, glutaric acid, adipic acid and α,ω-decanedicarboxylic acid;

polyesters formed from terephthalic acid and aliphatic dialcohols having 2 to 18 carbon atoms such as for example ethylene glycol, propanediol, 1,4-butanediol, 1,6-hexanediol or 1,8-octanediol.

Polyesters mentioned above can be terminated for example with monoalcohols such as for example 4 to 12 carbon atoms, for example n-butanol, n-hexanol, n-octanol, n-decanol or n-dodecanol.

Polyesters mentioned above can be terminated for example with monocarboxylic acids such as for example stearic acid.

Useful polymers further include melamine-formaldehyde resins, urea-formaldehyde resins, N,N-dimethylol-4,5-dihydroxyethyleneureas which may be etherified with C₁-C₅ alcohols

The molecular weight of the organic polymer or polymers can be selected within wide limits. The weight average molecular weight M_{w} can be in the range from 1000 to 10,000,000 g/mol and preferably in the range from 2500 to 5,000,000 g/mol, determined by at least one of the following methods: light scattering, gel permeation chromatography (GPC), viscometry. When a polymer from the group of the polyolefins is used, for example polyethylene, polypropylene or polyisobutylene, and also copolymers of ethylene with propylene, butylene or 1-hexene, the molecular weight will advantageously be in the range from 30,000 to 5,000,000 g/mol.

The width of the molecular weight distribution is not critical as such and can be in the range from 1.1 to 20. It is customarily in the range from 2 to 10.

In one embodiment of the present invention, the fraction of the organic polymer or polymers described above is at least 0.1 g/l of the aqueous liquor, preferably at least 1 g/l and more preferably at least 10 g/l. The maximum fraction is for example 500 g/l, preferably 250 g/l and more preferably 100 g/l.

In one embodiment of the present invention, the organic polymer or polymers are not soluble in the aqueous liquor, not soluble meaning in the context of organic polymers for the purposes of the present invention that at room temperature solubility in the liquor is less than 1 g/l and more preferably less than 0.1 g/l.

One embodiment of the present invention comprises using at least two different organic polymers.

In one embodiment of the present invention, at least one organic polymer can be present in the form of particles having a measure of central tendency particle diameter in the range from 0.1 to 50 μm, preferably from 0.5 to 30 μm and more preferably up to 20 μm (median value, number average).

At least one aqueous liquor used in the process of this invention comprises one organic or inorganic solid in particulate form that differs from the polymer or polymers described above, for example in a fraction of at least 5.5 g/l, preferably at least 7 g/l and more preferably at least 10 g/l The maximum fraction can be about 150 g/l in total. The further solid can be inorganic or organic in nature; preferably, it is inorganic.

Examples of suitable inorganic or organic solids are polyethylene, polypropylene, polyisobutylene and polystyrene and also copolymers thereof with each other or with one or more further olefins such as for example styrene, methyl acrylate, ethyl acrylate, methyl methacrylate, butyl acrylate, butyl methacrylate, 2-ethylhexyl acrylate, 2-ethylhexyl methacrylate, maleic anhydride or N-methylmaleimide. A preferred polyethylene or polypropylene is described for example in EP-A 0 761 696.

Particularly useful inorganic or organic solids include inorganic materials, especially solid inorganic oxides, carbonates, phosphates, silicates or sulfates of groups 3 to 14 of the periodic table, for example calcium oxide, silicon dioxide or aluminum oxide, calcium carbonate, calcium sulfate or calcium silicate, of which aluminum oxide and silicon dioxide are preferred. Particular preference is given to silicon dioxide in its silica gel form. Very particular preference is given to pyrogenic silica gels. Solid inorganic oxides can be hydrophobicized thermally by heating to 400-800° C. or preferably through physisorbed or chemisorbed organic or organometallic compounds. For this, particles are reacted prior to the coating step with, for example, organometallics which comprise at least one functional group, for example alkyllithium compounds such as methyllithium, n-butyllithium or n-hexyllithium, or silanes such as for example hexamethyldisilazane, octyltrimethoxysilane and especially halogenated silanes such as trimethylchlorosilane or dichlorodimethylsilane.

One embodiment of the present invention utilizes a mixture of hydrophobicized solid inorganic oxide with the corresponding nonhydrophobicized inorganic oxide, for example in weight fracations of 100:0 to 0:100, preferably 99:1 to 60:40 and more preferably 99:1 to 80:20.

At least one organic or inorganic solid is preferably hydrophobic. Hydrophobic is herein to be understood as meaning that its solubility is below 1 g/l and preferably below 0.3 g/l (determined at room temperature).

Inorganic solids can preferably be porous in nature. The porous structure is best characterized in terms of the BET surface area measured in accordance with German standard DIN 66131. Inorganic solids used can preferably have a BET surface area in the range from 5 to 1000 m²/g, preferably in the range from 10 to 800 m²/g and more preferably in the range from 20 to 500 m²/g.

In one embodiment of the present invention, at least one of the inorganic or organic solids is present in particulate form. The measure of central tendency particle diameter (median value, number average) is at least 1 nm, preferably at least 3 nm and more preferably at least 6 nm. The maximum particle diameter (median value, number average) is 1000 nm, preferably 350 nm and more preferably 100 nm. The particle diameter can be measured using commonly used methods such as for example transmission electron microscopy.

The weight ratio of organic polymer to organic or inorganic solid in particulate form is generally in the range from 9:1 to 1:9, preferably in the range from 4:1 to 1:4 and more preferably in the range from 7:3 to 4:6.

In one embodiment of the present invention, at least one of the inorganic or organic solids is present in the form of spherical particles, which is intended to comprise particulate solids where at least 75% by weight and preferably at least 90% by weight is present in spherical form while other particles are present in granular form.

In one embodiment of the present invention, at least one of the inorganic or organic solids can form aggregates and/or agglomerates. When one or more inorganic or organic solids are present in the form of aggregates and/or agglomerates, which can consist of from 2 to several thousand primary particles and which in turn can have a spherical form, the particulars concerning particle form and size relate to primary particles.

At least one liquor used in the process of the present invention comprises at least one emulsifier selected from emulsifiers of the general formula I

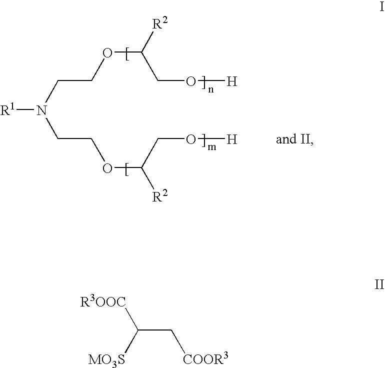

where:
R¹ is selected from C₆-C₄₀-alkyl, for example n-hexyl, iso-hexyl, n-heptyl, iso-heptyl, n-octyl, iso-octyl, n-nonyl, n-decyl, iso-decyl, n-undecyl, n-dodecyl, iso-dodecyl, n-tridecyl, n-tetradecyl, iso-tetradecyl, n-pentadecyl, n-hexadecyl, n-octadecyl, n-eicosyl, n-C₃₀H₆₁, n-C₄₀H₈₁, C₃-C₄₀-alkenyl having one to five C—C double bonds, which C—C double bonds can be for example isolated or conjugated. Examples which may be mentioned are allyl, —(CH₂)₂—CH═CH₂, all-cis-(CH₂)₈—(CH═CH—CH₂)₃CH₃, all-cis-(CH₂)₈—(CH═CH—CH₂)₂(CH₂)₄CH₃, all-cis-(CH₂)₈—CH═CH—(CH₂)₇CH₃,
R² is at each instance the same or different and selected from hydrogen and methyl, preferably methyl,
m and n are the same or different and are each selected from integers in the range from 0 to 10, preferably 1 or 2 and more preferably 2,
R³ is at each instance the same or different and selected from hydrogen and
   C₆-C₂₀-alkyl, for example n-hexyl, iso-hexyl, n-heptyl, iso-heptyl, n-octyl, iso-octyl, n-nonyl, n-decyl, iso-decyl, n-undecyl, n-dodecyl, iso-dodecyl, n-tridecyl, n-tetradecyl, iso-tetradecyl, n-pentadecyl, n-hexadecyl, n-octadecyl, n-eicosyl,
M is an alkali metal or ammonium,

The fraction of emulsifier can be chosen within wide limits and can be in the range from 0.1 to 200 g/l, preferably in the range from 0.2 to 100 g/l and more preferably up to 50 g/l of aqueous liquor.

Aqueous liquors used in the process of the present invention may have added to them, to adjust their viscosity, one or more thickeners which can be of natural or synthetic origin for example. Suitable synthetic thickeners are poly(meth)acrylic compounds, polycarboxylic acids, polyethers, polyimines, polyamides and polyurethanes, especially copolymers comprising 85% to 95% by weight of acrylic acid, 4% to 14% by weight of acrlamide and about 0.01% to 1% by weight of the (meth)acrylamide derivative of the formula V

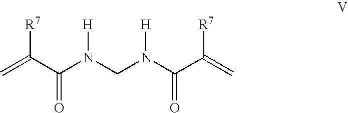

having molecular weights M_{w} in the range from 100,000 to 200,000 g/mol, in each of which R⁷ is methyl or preferably hydrogen. Examples of thickeners of natural origin are agar, carrageenan, modified starch and modified cellulose.

The amount of thickener used can be for example in the range from 0% to 10% by weight, based on liquor used in the process of the present invention, preferably in the range from 0.05% to 5% by weight and more preferably in the range from 0.1% to 3% by weight.

Liquors used in the process of the present invention preferably have a room-temperature dynamic viscosity in the range from 1 to 5000 mPa·s, preferably in the range from 2 to 4000 mPa·s and more preferably in the range from 5 to 2000 mPa·s, measured for example using a Brookfield viscometer in accordance with ASTM D2196-81.

The process of the present invention is carried out by treating absorbent material with at least one aqueous liquor. It is possible to carry out plural treatment steps with identical or different aqueous liquors.

In one embodiment of the present invention, the process of the present invention comprises treating absorbent material and especially textile first with an aqueous liquor which comprises at least one organic polymer and further an organic or preferably inorganic solid in particulate form and at least one emulsifier of the general formula I or II and subsequently with a new aqueous liquor which comprises organic polymer but no further organic or inorganic solid in particulate form.

In one embodiment of the present invention, the process of the present invention comprises treating absorbent material and especially textile first with an aqueous liquor which comprises at least one organic polymer and further an organic or preferably an inorganic solid in particulate form and at least one emulsifier of the general formula I or II and subsequently with a new aqueous liquor which comprises another organic polymer and at least one emulsifier of the general formula I or II but no further organic or inorganic solid in particulate form.

In a preferred embodiment of the present invention, the process of the present invention comprises treating the textile first with an aqueous liquor which comprises at least one organic polymer and further an organic or preferably an inorganic solid in particulate form and at least one emulsifier of the general formula I or II and subsequently with a new aqueous liquor which comprises no further polymer but comprises the inorganic solid in particulate form already used in the first step and at least one emulsifier of the general formula I or II.

The temperature at which the process of the present invention is carried out is as such not critical. The liquor temperature is can be in the range from 10 to 80° C., preferably in the range from 15 to 50° C.

The process of the present invention can be carried out with machines commonly used for the finishing of absorbent materials and especially textiles for example one or more pad-mangles. Preference is given to vertical textile feed pad-mangles, where the essential element comprises two rolls in pressed contact with each other through which the textile is led. The liquid is filled in above the rolls and wets the textile. The pressure causes the textile to be squeezed off and ensures a constant add-on.

A specific embodiment of the present invention utilizes a pad-mangle operated with a textile feed in the range from 1 to 40 m/min and preferably up to 30 m/min.

Liquor pickup can be chosen such that the process of the present invention provides a liquor pickup in the range from 25% by weight to 85% by weight and preferably in the range from 40% by weight to 70% by weight.

A specific embodiment of the present invention combines foam application of an aqueous liquor with a pad-mangle. Another embodiment of the present invention combines a doctor application of aqueous liquor with a pad-mangle. Another embodiment of the present invention combines a spray application of aqueous liquor with a pad-mangle. Another embodiment of the present invention combines a roll application of aqueous liquor with a pad-mangle.

The treated absorbent and especially textile material after the treatment according to this invention can be dried by methods customary in the textile industry.

The treatment according to the present invention can be followed by a heat treatment, which can be operated continuously or batchwise. The duration of the heat treatment can be chosen within wide limits. The heat treatment can typically be carried out for from about 10 seconds to about 30 minutes, especially from 30 seconds to 5 minutes. The heat treatment is carried out by heating to temperatures of up to 180° C., preferably up to 150° C. It is of course necessary to adapt the temperature of the heat treatment to the sensitivity of the fabric.

An example of a suitable method of heat treatment is hot air drying. Another suitable heat-treament method is to use one or more IR radiators.

In one embodiment of the present invention, the absorbent and especially textile material to be treated, is provided with a bonding layer prior to the treatment according to the present invention. The bonding layer can be provided using a primer. The application of a primer is preferable when synthetic fibers are to be finished.

In one embodiment of the present invention, the bonding layer applied to the absorbent and especially textile material to be treated can be for example one or more polymers, in which case the polymer synthesis can also be carried out on the absorbent and especially textile material to be treated. Particularly useful polymers have crosslinked or crosslinking-capable groups, for example natural or synthetic polymers having free hydroxyl groups, carbonyl groups, primary or secondary amino groups or thiol groups. Examples of very useful polymers are lignin, polysaccharides, polyvinyl alcohol and polyethyleneimine. Crosslinking can be accomplished for example by subsequent reaction with for example isocyanates, dimethylolurea or N,N-dimethylol-4,5-dihydroxyethyleneurea (DMDHEU). Other particularly preferred crosslinkers are melamine-formaldehyde resins, which can have been etherified with methanol.

In another embodiment, when polyesters or polyamides are to be treated, from 0.01% to 1% by weight and preferably from 0.1 to 0.5% by weight of the textile is saponified by partial saponification with strong alkalis such as aqueous sodium hydroxide solution or potassium hydroxide solution.

The present invention further provides absorbent materials and especially textile finished by the process of the present invention. Finishing according to the present invention provides the present invention's absorbent materials and especially textiles with one or more coats. The present invention's absorbent materials and especially textiles exhibit particularly good soil- and water-repellent performance. The present invention's absorbent materials and especially textiles further exhibit very good mechanical strength. In absorbent materials, and especially textiles, coated according to the present invention, the solid or solids used are preferably isotropically or substantially isotropically dissipated throughout the finishing coat, i.e. no concentration difference is observed in the boundary layer between the finishing coat and the surrounding atmosphere.

In one embodiment, the present invention's absorbent materials and especially textiles comprise from 0.5 to 50 g/m² of coating, preferably from 1 to 20 g/m² of coating and more preferably from 1.5 to 17 g/m² of coating.

The present invention further provides aqueous liquors comprising at least one organic polymer, at least one organic or inorganic solid in particulate form, and at least one emulsifier selected from emulsifiers of the general formula I

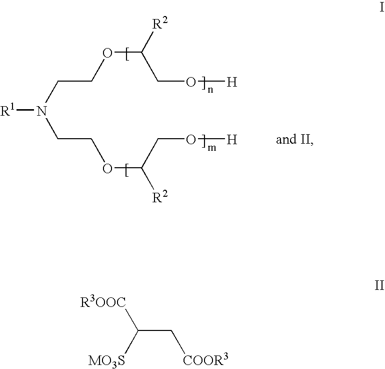

where the variables are each as defined above. The liquors of the present invention are useful for example for finishing absorbent materials and especially textiles.

The liquors of the present invention may comprise further components, for example one or more organic solvents.

The present invention further provides for the use of the present invention's liquors for finishing absorbent materials and especially textiles.

The present invention further provides a process for producing aqueous liquors, hereinafter also referred to as production process of the present invention. The production process of the present invention comprises the mixing of the following components:

at least one organic polymer,

at least one organic or inorganic solid in particulate form,

water, and

if appropriate one or more organic solvents,

and one or more emulsifiers of the general formula I or II.

The production process of the present invention can customarily be carried out at temperatures ranging from room temperature up to about 100° C., room temperature being preferred.

The production process of the present invention comprises in general a homogenizing step, for example by mechanical or pneumatic stirring, shaking, ultrasonication or a combination thereof. In some cases, however, the homogenizing step can be dispensed with.

The order in which the components are added is in principle freely choosable. For instance, the first step can be to prepare a water- and solvent-free mixture of polymer and organic or inorganic solid and then to disperse the dry mixture in organic solvent or mixture of water and organic solvent and emulsifier of the general formula I or II or in water and emulsifier of the general formula I or II.

In one embodiment of the production process of the present invention, the initial step is to produce formulations which comprise organic polymer, organic or inorganic solid material in particulate form, one or more emulsifiers of the general formula I or II and also if appropriate water and if appropriate one or more organic solvents. Prior to conducting the present invention's treatment of absorbent materials, a liquor which is in accordance with the present invention is prepared by diluting formulation in accordance with the present invention with water and if appropriate further organic solvent. It is preferable that the formulations of the present invention comprise not more than 15% by weight, preferably about 0.1-10% by weight and more preferably up to 5% by weight of water. Formulations according to the present invention can also be free of water.

The present invention further provides formulations comprising organic polymer, organic or inorganic solid material in particulate form, one or more emulsifiers of the general formula I or II and also if appropriate water and if appropriate one or more organic solvents, wherein the water fraction can be about 0.1-10% by weight, and preferably up to 5% by weight. Formulations according to the present invention are particularly useful for producing aqueous liquors according to the present invention.

The invention is illustrated by examples.

### EXAMPLE 1

### Production of Inventive Aqueous Liquors

### EXAMPLE 1.1

### Production of Inventive Aqueous Liquor 1.1

The following were mixed in a flask by mechanical stirring:

872.8 g of distilled water,

68.1 g of an aqueous dispersion (solids content 20% by weight) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography),

86.5 g of an aqueous dispersion (solids content 20% by weight) of a random copolymer formed from 20% by weight of acrylic acid, 80% by weight of ethylene, M_{w}:

20,000 g/mol, neutralized with N,N-dimethylethanolamine, pH between 8.5 and 9.5.

Then 12.8 g of dimethylsiloxane group modified pyrogenic silica having a BET surface area of 225 m²/g, determined in accordance with German standard specification DIN 66131, primary particle size: 10 nm (median value, number average) were added and

88 g of amine of the formula 1.1

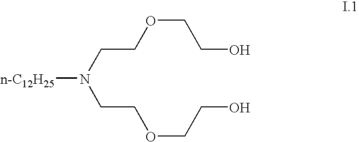

neutralized with 32% by weight of aqueous HCl were added and dispersed for 10 minutes (Ultraturrax stirrer) to give the inventive aqueous liquor 1.1, which had a pH of 7.5.

### EXAMPLE 1.2

### Production of Inventive Aqueous Liquor 1.2

The following were mixed in a flask by mechanical stirring:

872.8 g of distilled water,

68.1 g of an aqueous dispersion (solids content 20% by weight) of a random copolymer formed from 10% by weight of methacrylic acid and 90% by weight of CH₂═C(CH₃)COO—CH₂—CH₂-n-CF₃ and having Mₙ 3000 g/mol (gel permeation chromatography),

86.5 g of an aqueous dispersion (solids content 20% by weight) of a random copolymer formed from 20% by weight of acrylic acid, 80% by weight of ethylene, M_{w}:

20 000 g/mol, neutralized with N,N-dimethylethanolamine, pH between 8.5 and 9.5. Then 12.8 g of dimethylsiloxane group modified pyrogenic silica having a BET surface area of 225 m²/g, determined in accordance with German standard specification DIN 66131, primary particle size: 10 nm (median value, number average) were added and

8.8 g of amine of the formula 1.2

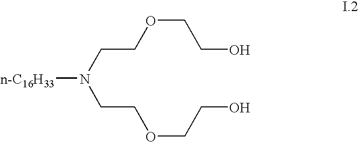

neutralized with 32% by weight of aqueous HCl were added and dispersed for 10 minutes (Ultraturrax stirrer) to give the inventive aqueous liquor 1.2, which had a pH of 7.5.

### EXAMPLE 1.3

### Production of Inventive Aqueous Liquor 1.3

The following were mixed in a flask by mechanical stirring:

872.8 g of distilled water,

68.1 g of an aqueous dispersion (solids content 20% by weight) of a random copolymer formed from 10% by weight of methacrylic acid and 90% by weight of CH₂═C(CH₃)COO—CH₂—CH₂-n-C₆F₁₃ and having Mₙ 3000 g/mol (gel permeation chromatography),

86.5 g of an aqueous dispersion (solids content 20% by weight) of a random copolymer formed from 20% by weight of acrylic acid, 80% by weight of ethylene, M_{w}: 20 000 g/mol, neutralized with N,N-dimethylethanolamine, pH between 8.5 and 9.5.

Then 12.8 g of dimethylsiloxane group modified pyrogenic silica having a BET surface area of 225 m²/g, determined in accordance with German standard specification DIN 66131, primary particle size: 10 nm (median value, number average) were added and

8.8 g of amine of the formula I.3

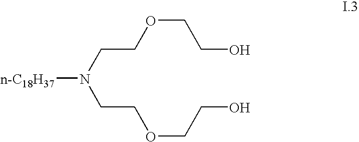

neutralized with 32% by weight of aqueous HCl were added and dispersed for 10 minutes (Ultraturrax stirrer) to give the inventive aqueous liquor 1.3., which had a pH of 7.5.

### EXAMPLE 2

### Textile Finishing

### EXAMPLE 2.1

### Treatment with Inventive Aqueous Liquor 1.1

### EXAMPLE 2.1.1

### Treatment of Polyester

A woven polyester fabric having a basis weight of 220 g/m² was treated with liquor 1.1 on a pad-mangle from Mathis (model HVF12085). The squeeze pressure of the rolls was 2.6 bar. This resulted in a liquor pickup of 60%. The application speed was 2 m/min. The treated polyester fabric was subsequently dried on a tenter at 120° C. The conclusive heat treatment took 3 min at 150° C. with circulating air. The invention treated polyester fabric 2.1.1 was obtained.

### EXAMPLE 2.1.2

### Treatment of Polyamide

A woven polyamide fabric having a basis weight of 160 g/m² was treated with liquor 1.1 on a pad-mangle from Mathis (model HVF12085). The squeeze pressure of the rolls was 2.6 bar. This resulted in a liquor pickup of 65%. The application speed was 2 m/min. The treated polyamide fabric was subsequently dried on a tenter at 120° C. The conclusive heat treatment took 3 min at 150° C. with circulating air. The invention treated polyamide fabric 2.1.2 was obtained.

### EXAMPLE 2.1.3

### Treatment of Polyacrylic

A woven polyacrylic fabric having a basis weight of 295 g/m² was treated with liquor 1.1 on a pad-mangle from Mathis (model HVF12085). The squeeze pressure of the rolls was 2.6 bar. This resulted in a liquor pickup of 50%. The application speed was 2 m/min. The treated polyacrylic fabric was subsequently dried on a tenter at 120° C. The conclusive heat treatment took 3 min at 150° C. with circulating air. The invention treated polyacrylic fabric 2.1.3, according to the invention, was obtained.

### EXAMPLES 2.2.1 TO 2.2.3 AND 2.3.1 TO 2.3.3

Examples 2.1.1 to 2.1.3 were repeated except that inventive aqueous liquor 1.1 was replaced by inventive aqueous liquor 1.2 in examples 2.2.1 to 2.2.3 and by inventive aqueous liquor 1.3 in examples 2.3.1 to 23.3.

3. Water repellency testing of textile samples treated according to the present invention

The textile sample treated according to the present invention and is to be tested was manually tensioned and fixed with nails to a flat wooden board whose inclination was continuously adjustable in the range from 1° to 90°. A cannula was then used to drop individual water droplets onto the textile sample from a height of 10 mm. The droplets had a mass of 4.7 mg. The angle of inclination was reduced in stages to that angle of inclination at which the droplets were just starting to be beaded off and there was no sign of adhesion. The results are given in Table 1.

Water imbibition was tested to Bundesmann, DIN 53888.

TABLE 1
Angle of inclination

| Textile sample No. | Angle of inclination [°] | Water imbibition |
|---|---|---|
| 2.1.1 | 7 | <20% by weight |
| 2.1.2 | 9 | <20% by weight |
| 2.1.3 | 6 | <20% by weight |
| 2.2.1 | 8 | <20% by weight |
| 2.2.2 | 7 | <20% by weight |
| 2.2.3 | 7 | <20% by weight |
| 2.3.1 | 5 | <20% by weight |
| 2.3.2 | 7 | <20% by weight |
| 2.3.3 | 8 | <20% by weight |

The inventive textile samples (polyester, polyamide, polyacrylic) each possessed excellent mechanical stability. For a check, they are each wound up and unwound 2000 times before the angle of inclination is redetermined. The angles of inclination had not changed from Table 1.

1-13. (canceled)

14. A process for finishing absorbent materials by treatment with
at least one aqueous liquor comprising
at least one organic polymer selected from polymers and copolymers of ethylenically unsaturated hydrophobic monomers which have a 25° C. solubility in water of less than 1 g/l,
at least one organic or inorganic solid in particulate form selected from polyethylene, polypropylene, polyisobutylene and polystyrene and also copolymers thereof with each other or with one or more further olefins and solid oxides, carbonates, phosphates, silicates or sulfates of groups 3 to 14 of the periodic table,
and at least one emulsifier selected from emulsifiers of the general formula I 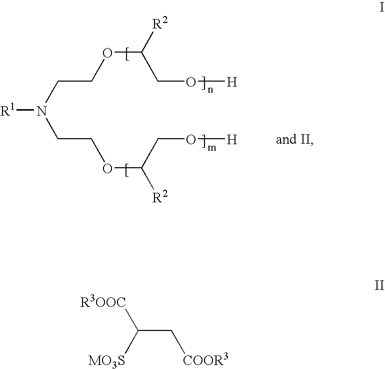
where
R¹ is selected from C₆-C₄₀-alkyl and C₃-C₄₀)-alkenyl having one to five C—C double bonds,
R² is at each instance the same or different and selected from hydrogen and methyl,
m and n are the same or different and each selected from integers in the range from 0 to 10,
R³ is at each instance the same or different and selected from hydrogen and C₆-C₂₀-alkyl,
M is an alkali metal or ammonium.

15. The process according to claim 14 wherein the or at least one of the organic or inorganic solids is hydrophobic.

16. The process according to claim 14 wherein the absorbent material surface is provided with a bonding layer prior to said treatment.

17. The process according to claim 14 wherein the solid or solids is or are one or more inorganic solids.

18. The process according to claim 14 wherein the organic or inorganic solid or solids are present in the liquor in a fraction of at least 5.5 g/l.

19. The process according to claim 14 wherein the organic or inorganic solid or solids have a particle diameter (median value, number average) in the range from 10 to 1000 nm.

20. The process according to claim 14 wherein the absorbent materials are textile materials.

21. Absorbent materials finished by a process according to claim 14.

22. Aqueous liquors comprising
at least one organic polymer selected from polymers and copolymers of ethylenically unsaturated hydrophobic monomers which have a 25° C. solubility in water of less than 1 g/l,
at least one organic or inorganic solid in particulate form selected from polyethylene, polypropylene, polyisobutylene and polystyrene and also copolymers thereof with each other or with one or more further olefins and solid oxides, carbonates, phosphates, silicates or sulfates of groups 3 to 14 of the periodic table.
and at least one emulsifier selected from emulsifiers of the general formula I 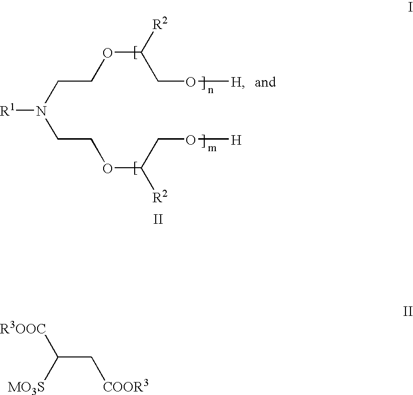
where:
R¹ is selected from C₆-C₄₀-alkyl and C₃-C₄₀-alkenyl having one to five C—C double bonds,
R² is at each instance the same or different and selected from hydrogen and methyl,
m and n are the same or different and each selected from integers in the range from 0 to 10,
R³ is at each instance the same or different and selected from hydrogen and C₆-C₂-alkyl,
M is a alkali metal or ammonium.

23. The method of using an aqueous liquors according to claim 21 for finishing absorbent materials.

24. A process for producing aqueous liquors according to claim 21 by mixing the following components
at least one organic polymer,
at least one organic or inorganic solid in particulate form water, and
at least one emulsifier selected from emulsifiers of the general formula I and II.

25. The method of using formulations for producing aqueous liquors according to claim 22 wherein the formulations comprise organic polymer, organic or inorganic so if material in particulate form, one or more emusifiers of the general formula I or II and if appropriate one or more organic solvents and also if appropriate water and the water fraction is not more than 15% by weight, based on all fractions of the formulation which are liquid at room temperature.

26. Formulations comprising organic polymer, organic or inorganic solid material in particulate form one or more emulsifiers of the general formula I or II of claim 22 and if appropriate one or more organic solvents and also if appropriate water, wherein the water fraction is not more than 15% by weight.
